(19) United States
(12) Patent Application Publication
(10) Pub. No.: US 2021/0141757 A1
(43) Pub. Date: May 13, 2021

(54) ADAPTIVE ADDRESS ARBITRATION OPTIMIZATION ON AN I3C BUS

(71) Applicant: QUALCOMM Incorporated, San Diego, CA (US)

(72) Inventors: Joy CHAKRABORTY, Hyderabad (IN); Subramanian Kizhakkenchery ANANTHANARAYANAN, Hyderabad (IN); Arun GOTHEKAR, Hyderabad (IN)

(21) Appl. No.: 16/681,380

(22) Filed: Nov. 12, 2019

(51) Int. Cl. G06F 13/42; G06F 13/364; G06F 13/16; G06F 1/324

(52) U.S. Cl. CPC G06F 13/4291; G06F 13/4295; G06F 2213/0016; G06F 13/1673; G06F 1/324; G06F 13/364

(57) ABSTRACT

Systems, methods, and apparatus for serial bus arbitration are described. A method for bus arbitration includes determining that at least one device coupled to a serial bus has been assigned a dynamic address with a non-zero most significant address bit, determining that all devices coupled to the serial bus have been assigned dynamic addresses that have a common zero-value address bit, initiating transmission of an arbitrable address header while a line driver coupled to a data line of the serial bus is configured for an open-drain mode of operation, and configuring the line driver coupled to the data line for a push-pull mode of operation when a bit in the arbitrable address header corresponding to the common zero-value address bit has a non-zero value on the data line. In one example, the serial bus may be operated in accordance with an I3C protocol.

### TECHNICAL FIELD

The present disclosure relates generally to an interface between processing circuits and peripheral devices and, more particularly, to address optimization techniques usable on a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol. In one example, a serial bus operated in accordance with Inter-Integrated Circuit (I2C bus or I²C) protocols. The I2C bus architecture was developed to connect low-speed peripherals to a processor, and the I2C bus can operate as a multi-drop bus. A two-wire I2C bus includes a Serial Data Line (SDA) that carries a data signal, and a Serial Clock Line (SCL) that carries a clock signal.

A serial bus may employ a multi-master protocol in which one or more devices can serve as a master and a slave for different messages transmitted on the serial bus. In one example, Improved Inter-Integrated Circuit (I3C) protocols may be used to control operations on a serial bus. I3C protocols are defined by the Mobile Industry Processor Interface (MIPI) Alliance and derive certain implementation aspects from the I2C protocol. Original implementations of the I2C protocol supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

In another example, the Radio Frequency Front-End (RFFE) interface defined by the MIPI Alliance provides a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communication device, multiple antennas and radio transceivers may support multiple concurrent RF links.

In another example, the system power management interface (SPMI) defined by the MIPI Alliance provides a hardware interface that may be implemented between baseband or application processors and peripheral components. In some implementations, the SPMI is deployed to support power management operations within a device.

As applications have become more complex, there is a continually increasing demand for improved bus management techniques that can reduce bus latency.

### SUMMARY

Certain aspects of the disclosure relate to systems, apparatus, methods and techniques that provide optimized adaptive address arbitration on a serial bus. The disclosed adaptive address arbitration procedures can reduce bus latency.

In various aspects of the disclosure, a method for bus arbitration includes determining that at least one device coupled to a serial bus has been assigned a dynamic address with a non-zero most significant address bit, determining that all devices coupled to the serial bus have been assigned dynamic addresses that have a common zero-value address bit, initiating transmission of an arbitrable address header while a line driver coupled to a data line of the serial bus is configured for an open-drain mode of operation, and configuring the line driver coupled to the data line for a push-pull mode of operation when a bit in the arbitrable address header corresponding to the common zero-value address bit has a non-zero value on the data line. The serial bus may be operated in accordance with an I3C protocol, for example.

In one aspect, the method includes transmitting a clock signal on a clock line of the serial bus. The clock signal may be transmitted with a higher frequency when the line driver coupled to the data line is configured for a push-pull mode of operation than when the line driver coupled to the data line is configured for an open-drain mode of operation.

In one aspect, determining that all devices coupled to the serial bus have been assigned dynamic addresses that have the common zero-value address bit includes performing a bitwise OR operation on the dynamic addresses of all devices coupled to the serial bus to obtain a resultant address. Each bit of the resultant address that has a zero value indicates a bit interval in the arbitrable address header that can be used to transition the line driver coupled to the data line from open-drain mode to push-pull mode. The common zero-value address bit may correspond to a bit in the resultant address that has greater significance than other zero-value bits in the resultant address. The bitwise OR operation may be performed after a dynamic address has been assigned to a slave device.

In various aspects of the disclosure, an apparatus includes a bus interface configured to couple the apparatus to a data line of serial bus, and a processor. The processor may be configured to determine that at least one device coupled to a serial bus has been assigned a dynamic address with a non-zero most significant address bit, determine that all devices coupled to the serial bus have been assigned dynamic addresses that have a common zero-value address bit, cause the bus interface to initiate transmission of an arbitrable address header while the line driver is configured for an open-drain mode of operation, and configure the line driver for a push-pull mode of operation when a bit in the arbitrable address header corresponding to the common zero-value address bit has a non-zero value on the data line.

In various aspects of the disclosure, a computer-readable medium stores code, instructions and/or data, including code which, when executed by a processor, causes the processor to determine that at least one device coupled to a serial bus has been assigned a dynamic address with a non-zero most significant address bit, determine that all devices coupled to the serial bus have been assigned dynamic addresses that have a common zero-value address bit, initiate transmission of an arbitrable address header while a line driver coupled to a data line of the serial bus is configured for an open-drain mode of operation, and configure the line driver coupled to the data line for a push-pull mode of operation when a bit in the arbitrable address header corresponding to the common zero-value address bit has a non-zero value on the data line.

In various aspects of the disclosure, an apparatus includes means for determining content of device addresses, configured to determine that at least one device coupled to a serial bus has been assigned a dynamic address with a non-zero most significant address bit and further configured to determine that all devices coupled to the serial bus have been assigned dynamic addresses that have a common zero-value address bit. The apparatus may include means for initiating transmission of an arbitrable address header while a line driver coupled to a data line of the serial bus is configured for an open-drain mode of operation, and means for configuring the line driver coupled to the data line for a push-pull mode of operation when a bit in the arbitrable address header corresponding to the common zero-value address bit has a non-zero value on the data line.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates certain aspects of an apparatus that includes multiple devices connected to a serial bus.

FIG. 4 illustrates certain aspects of the timing relationship between SDA and SCL wires on a conventional I2C bus.

FIG. 5 is a timing diagram that illustrates timing associated with multiple frames transmitted on an I2C bus.

FIG. 6 illustrates timing related to a command word sent to a slave device in accordance with I2C protocols.

FIG. 7 includes a timing diagram that illustrates an example of signaling on a serial bus when the serial bus is operated in a mode of operation defined by I3C specifications.

FIG. 8 illustrates a non-arbitrable address header and an arbitrable address header that may be transmitted on a serial bus operated in accordance with I3C protocols.

FIG. 9 illustrates a circuit that can implement an adaptive address optimization technique according to certain aspects disclosed herein.

FIG. 10 illustrates address arbitration header timing when a bus master employs an adaptive address optimization technique according to certain aspects disclosed herein.

FIG. 11 illustrates an apparatus employing a processing circuit that may be adapted according to certain aspects disclosed herein.

FIG. 12 is a flowchart illustrating certain aspects of a method for bus arbitration that may be performed at a master device in accordance with certain aspects disclosed herein.

FIG. 13 illustrates an apparatus involved in bus arbitration in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects and features will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include application-specific IC (ASIC) devices, SoCs and/or other IC devices often employ a shared communication interface that may include a serial bus or other data communication link to connect processors with modems and other peripherals. The serial bus may be operated in accordance with specifications and protocols defined by a standards body. In certain implementations, the serial bus is operated in accordance with protocols such as I2C and/or I3C protocols, which define timing relationships between signals transmitted over the serial bus. Certain aspects disclosed herein relate to systems, apparatus, methods and techniques that provide an arbitration scheme that can be used on a serial bus to minimize latency for high priority devices and improve overall link performance.

An address optimization scheme defined by I3C specifications relies on forcing logic zero values for the most significant bit (A6) in all dynamic addresses used on the serial bus. Certain aspects disclosed herein provide an adaptive address optimization technique that can extend the address arbitration optimization technique defined by I3C specifications. The adaptive address optimization technique can operate in circumstances where the conventional I3C address arbitration optimization procedure is unusable, including where at least one slave device is allocated a dynamic address that has the most significant bit of its dynamic address set to logic 1. In some implementations, an adaptive address optimization circuit can identify when an address bit is set to logic zero for all slave devices. The adaptive address optimization circuit may be used to determine that push-pull mode can be enabled when the SDA line of a serial bus remains at the logic 1 level during a corresponding bit interval bit of an arbitrable address header.

Example of an Apparatus with a Serial Data Link

According to certain aspects of this disclosure, a serial data link may be employed to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similarly functioning device.

FIG. 1 illustrates an example of an apparatus 100 that employs a data communication bus and that may be adapted to operate in accordance with certain aspects disclosed herein. The apparatus 100 may include a processing circuit 102 having multiple circuits and/or devices 104, 106 and/or 108, which may be implemented in one or more ASICs or in an SoC for example. In one example, the apparatus 100 may be a communication device and the processing circuit 102 includes a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or in other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include non-transitory media, such as read-only memory (ROM), random-access memory (RAM), electrically erasable programmable ROM (EEPROM), flash cards, or other types memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with standards-defined communication specifications or protocols. The processing circuit 102 may include or control a power management function that configures and manages the operation of the apparatus 100.

FIG. 2 illustrates a communication link 200 in which multiple devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols that define signaling state of clock and data signals, where timing information is embedded in the transmission of the symbols.

FIG. 3 illustrates certain aspects of an apparatus 300 that includes multiple devices 302, and 322₀-322_{N} coupled to a serial bus 320. The devices 302 and 322₀-322_{N} may be provided in one or more semiconductor IC devices, such as an application processor, SoC or ASIC. In various implementations, the devices 302 and 322₀-322_{N} can include, support or operate as a modem, a signal processing device, a display driver, a camera, a user interface, a sensor, a sensor controller, a media player, a transceiver, and/or other such components or devices. In some examples, one or more of the slave devices 322₀-322_{N} may be used to control, manage or monitor a sensor device. Communication between devices 302 and 322₀-322_{N} over the serial bus 320 is controlled by a bus master device 302. Certain types of bus can support multiple bus master devices 302.

In one example, a bus master device 302 may include an interface controller 304 that manages access to the serial bus 320, configures dynamic addresses for slave devices 322₀-322_{N} and/or generates a clock signal 328 to be transmitted on a clock line 318 of the serial bus 320. The bus master device 302 may include configuration registers 306 or other storage 324, and/or control logic 312 configured to handle protocols and/or higher-level functions. The control logic 312 may include a processing circuit such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic circuits and/or storage devices. In one example, the transmitter encodes and transmits data based on timing in the clock signal 328 provided by a clock generation circuit 308. Other timing clock signals 326 may be provided for the use of by the control logic 312 and other functions, circuits or modules. The line drivers/receivers 314a and 314b may be configurable to operate in open-drain and push-pull modes.

At least one device 322₀-322_{N} can be configured to operate as a slave device on the serial bus 320 and may include circuits and modules that support a display, an image sensor, and/or circuits and modules that control and communicate with one or more sensors that measure environmental conditions. In one example, a slave device 322o configured to operate as a slave device may provide a control function, module or circuit 332 that includes circuits and modules to support a display, an image sensor, and/or circuits and modules that control and communicate with one or more sensors that measure environmental conditions. The slave device 322o may include configuration registers 334 or other storage 336, control logic 342, a transceiver 340 and line drivers/receivers 344a and 344b. The control logic 342 may include a processing circuit such as a state machine, sequencer, signal processor or general-purpose processor. The transceiver 310 may include receiver, transmitter and common circuits, where the common circuits may include timing, logic circuits and/or storage devices. In one example, the transmitter encodes and transmits data based on timing in a clock signal 348 provided by clock generation and/or recovery circuits 346. The clock signal 348 may be derived from a signal received from the clock line 318. Other timing clock signals 338 may be provided for the use of the control logic 342 and other functions, circuits or modules. The line drivers/receivers 344a and 344b may be configurable to operate in open-drain and push-pull modes.

The serial bus 320 may be operated in accordance with an I2C, I3C, RFFE, SPMI, or another protocol. At least one device 302, 322₀-322_{N} may be configured to operate as a master device and a slave device on the serial bus 320. Two or more devices 302, 322₀-322_{N} may be configured to operate as a master device on the serial bus 320.

In some implementations, the serial bus 320 may be operated in accordance with an I3C protocol. Devices that communicate using the I3C protocol can coexist on the same serial bus 320 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 320, in addition to data formats and aspects of bus control. In some aspects, the I2C and I3C protocols may define direct current (DC) characteristics affecting certain signal levels associated with the serial bus 320, and/or alternating current (AC) characteristics affecting certain timing aspects of signals transmitted on the serial bus 320. In some examples, a 2-wire serial bus 320 transmits data on a data line 316 and a clock signal on the clock line 318. In some instances, data may be encoded in the signaling state, or transitions in signaling state of the data line 316 and the clock line 318.

Data Transfers Over a Serial Bus

Examples of data transfers including control signaling, command and payload transmissions are provided by way of example. The examples illustrated relate to I2C and I3C communication for convenience. However, certain concepts disclosed herein are applicable to other bus configurations and protocols, including RFFE and SPMI configurations and protocols. In one example, I3C protocols include an I3C HDR protocol that encodes data in ternary symbols (HDR-TSP), and HDR-TSP timeslots may be defined in terms of HDR-TSP words, where each slot may be expressed as a set of six successive recovered clock pulses, which is the equivalent number of clock pulses for an HDR-TSP word. In another example, I3C protocols include an I3C HDR double data rate (HDR-DDR) protocol, where timeslots may be defined in terms of HDR-DDR words and/or expressed as the number of clock pulses used to transmit an HDR-DDR word. The concepts disclose herein may be applicable to a serial bus operated in accordance with a protocol that supports multiple data lanes.

FIG. 4 includes timing diagrams 400 and 420 that illustrate the relationship between the SDA wire 402 and the SCL wire 404 of a serial bus operated in certain I2C and I3C modes. The first timing diagram 400 illustrates the timing relationship between the SDA wire 402 and the SCL wire 404 while data is being transferred on a conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid such that the state of the SDA wire 402 is not permitted to change when the SCL wire 404 is in the high logic state.

In one example, specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for a setup time 406 (t_{SU}) before occurrence of the pulse 412, and a hold time 408 (t_{Hold}) after the pulse 412 terminates. The signaling state of the SDA wire 402 is expected to be stable during the setup time 406 and the hold time 408. The setup time 406 defines a maximum time period after a transition 416 between signaling states on the SDA wire 402 until the arrival of the rising edge of the pulse 412 on the SCL wire 404. The hold time 408 defines a minimum time period after the falling edge of the pulse 412 on the SCL wire 404 until a next transition 418 between signaling states on the SDA wire 402. The I2C Specifications also define a minimum duration 414 for a low period (t_{Low}) for the SCL wire 404. The data on the SDA wire 402 is typically stable and/or can be captured for the duration 410 (t_{HIGH}) when the SCL wire 404 is in the high logic state after the leading edge of the pulse 412.

Certain protocols provide for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

The second timing diagram 420 of FIG. 4 illustrates signaling states on the SDA wire 402 and the SCL wire 404 between data transmissions on a serial bus. A start condition 422 is defined to permit the current bus master to signal that data is to be transmitted. The start condition 422 occurs when the SDA wire 402 transitions from high to low while the SCL wire 404 is high. The bus master initially transmits the start condition 422, which may be also be referred to as a start bit, followed by a 7-bit address of an I2C slave device with which it wishes to exchange data. The address is followed by a single bit that indicates whether a read or write operation is to occur. The addressed slave device, if available, responds with an ACK bit. If no slave device responds, the bus master may interpret the high logic state of the SDA wire 402 as a NACK. The master and slave devices may then exchange bytes of information in frames, in which the bytes are serialized such that the most significant bit (MSB) is transmitted first. The transmission of the byte is completed when a stop condition 424 is transmitted by the master device. The stop condition 424 occurs when the SDA wire 402 transitions from low to high while the SCL wire 404 is high.

FIG. 5 includes diagrams 500 and 520 that illustrate timing associated with data transmissions on a serial bus operated in accordance with an I2C or I3C protocol. As illustrated in the first diagram 500, an idle period 514 may occur between a stop condition 508 and a consecutive start condition 510. In the illustrated example, the SDA line 502 and SCL line 504 may be held and/or driven to a high voltage state during the idle period 514. This idle period 514 may be prolonged, and may result in reduced data throughput when the serial bus remains idle between the stop condition 508 and the next start condition 510. In operation, a busy period 512 commences when the I2C bus master transmits a first start condition 506, followed by data. The busy period 512 ends when the bus master transmits a stop condition 508 and the idle period 514 ensues. The idle period 514 ends when a second start condition 510 is transmitted.

The second timing diagram 520 illustrates a method by which the number of occurrences of an idle period 514 may be reduced. In the illustrated example, data is available for transmission before a first busy period 532 ends. The bus master device may transmit a repeated start condition 528 (Sr) rather than a stop condition. The repeated start condition 528 terminates the preceding data transmission and simultaneously indicates the commencement of a next data transmission. The state transition on the SDA wire 522 corresponding to the repeated start condition 528 is identical to the state transition on the SDA wire 522 for a start condition 526 that occurs after an idle period 530. For both the start condition 526 and the repeated start condition 528, the SDA wire 522 transitions from high to low while the SCL wire 524 is high. When a repeated start condition 528 is used between data transmissions, a first busy period 532 is immediately followed by a second busy period 534.

FIG. 6 illustrates an example of the timing 600 associated with an address word sent to a slave device in accordance with certain I2C and/or I3C protocols. In the example, a master device initiates the transaction with a start condition 606, whereby the SDA wire 602 is driven from high to low while the SCL wire remains high. The master device then transmits a clock signal on the SCL wire 604. The seven-bit address 610 of a slave device is then transmitted on the SDA wire 602. The seven-bit address 610 is followed by a Write/Read command bit 612, which indicates “Write” when low and “Read” when high. The slave device may respond in the next clock interval 614 with an acknowledgment (ACK) by driving the SDA wire 602 low. If the slave device does not respond, the SDA wire 602 is pulled high and the master device treats the lack of response as a NACK. The master device may terminate the transaction with a stop condition 608 by driving the SDA wire 602 from low to high while the SCL wire 604 is high. This transaction can be used to determine whether a slave device with the transmitted address coupled to the serial bus is in an active state.

FIG. 7 illustrates signaling 700 on a serial bus when the serial bus is operated in a single data rate (SDR) mode of operation defined by I3C specifications. Data transmitted on a first wire of the serial bus, which may be referred to as the Data wire 702, SDA or SDATA, may be captured using a clock signal transmitted on a second wire of the serial bus, which may be referred to as the Clock wire 704, SCL or SCLOCK. During data transmission, the signaling state 712 of the Data wire 702 is expected to remain constant for the duration of the pulses 714 when the Clock wire 704 is at a high voltage level. Transitions on the Data wire 702 when the Clock wire 704 is at the high voltage level indicate a START condition 706, a STOP condition 708 or a Repeated Start 710.

On an I3C serial bus, a START condition 706 is defined to permit the current bus master to signal that data is to be transmitted. The START condition 706 occurs when the Data wire 702 transitions from high to low while the Clock wire 704 is high. The bus master may signal completion and/or termination of a transmission using a STOP condition 708. The STOP condition 708 is indicated when the Data wire 702 transitions from low to high while the Clock wire 704 is high. A Repeated Start 710 may be transmitted by a bus master that wishes to initiate a second transmission upon completion of a first transmission. The Repeated Start 710 is transmitted instead of a STOP condition 708, and has the significance of a STOP condition 708 followed immediately by a START condition 706. The Repeated Start 710 occurs when the Data wire 702 transitions from high to low while the Clock wire 704 is high.

The bus master may transmit an initiator 722 that may be a START condition 706 or a Repeated Start 710 prior to transmitting an address of a slave, a command, and/or data. FIG. 7 illustrates a command code transmission 720 by the bus master. The initiator 722 may be followed in transmission by a predefined address header 724 and a command code 726. The command code 726 may, for example, cause the serial bus to transition to a desired mode of operation. In some instances, data 728 may be transmitted. The command code transmission 720 may be followed by a terminator 730 that may be a STOP condition 708 or a Repeated Start 710.

Certain serial bus interfaces support signaling schemes that provide higher data rates. In one example, I3C specifications define multiple high data rate (HDR) modes, including a high data rate, double data rate (HDR-DDR) mode in which data is transferred at both the rising edge and the falling edge of the clock signal.

An I3C bus may be switched between SDR and DDR modes. FIG. 7 includes an example of signaling 740 transmitted on the Data wire 702 and the Clock wire 704 to initiate certain mode changes. The signaling 740 is defined by I3C protocols for use in initiating restart, exit and/or break from I3C HDR modes of communication. The signaling 740 includes an HDR Exit 742 that may be used to cause an HDR break or exit. The HDR Exit 742 commences with a falling edge 744 on the Clock wire 704 and ends with a rising edge 746 on the Clock wire 704. While the Clock wire 704 is in a low signaling state, four pulses are transmitted on the Data wire 702. I2C devices ignore the Data wire 702 when no pulses are provided on the Clock wire 704.

In-Band Interrupts and Address Arbitration on a Serial Bus

In-band interrupts may be used to gain access to an I3C bus in order to transmit high-priority and/or low-latency messages. A device other than the current bus master may assert an in-band interrupt during transmission of certain address fields to initiate an arbitration process that can enable the asserting device to gain access to a serial bus. The serial bus may be operated in a mode in which data is transmitted on a data line in accordance with timing provided by a clock signal transmitted on a clock line. FIG. 8 illustrates a non-arbitrable address header 800 and an arbitrable address header 820 that may be transmitted on the SDA line 802 of the serial bus in accordance with I3C protocols. I3C arbitrable address headers 820 are transmitted after a START condition 706. An address header 724 transmitted after a Repeated Start 710 is not arbitrable. A device may use an I3C arbitrable address header to assert an In-Band Interrupt, make a secondary master request, or indicate a hot-join request.

A non-arbitrable address header 800 is transmitted using push-pull drivers, while open-drain drivers are enabled during transmission of an arbitrable address header 820. Rising edges 806 in a non-arbitrable address header 800 are actively driven by a push-pull driver and enable a shorter bit interval 808 than the bit interval 824 available during an open-drain transmission, due to the slow rise time of the pulled-up edges 822 in an arbitrable address header 820. In FIG. 8, the bit intervals 808, 824 are not depicted on a common scale.

A clock signal transmitted on the SCL line 804 provides timing information that is used by a slave device to control transmission of bits on the SDA line 802, where the clock signal may be used by a receiving device for sampling and/or capturing bits of data transmitted on the SDA line 802. A bus master device may read one or more registers on a slave device or secondary master device that wins arbitration. In conventional systems, the bus master device may provide clock pulses in a clock signal that have a period sufficient to successfully read the slowest possible device coupled to the serial bus. Each slave device has different operating characteristics and limitations that affect the response time of the slave device. In one example, the response time of a slave device may be affected by the physical distance between the slave device and the bus master device. In another example, the response time of a slave device may be affected by the processing capabilities of the slave device, where a slower controller, state machine or other processor in the slave device may delay responses transmitted by the slave device during in-band interrupt handling and/or processing.

A primary master device, which may be referred to as a bus owner master or BoM, manages an initial dynamic address assignment procedure. The BoM initiates the dynamic address assignment procedure by command transmitted to enable each active slave device to identify itself with an address that is based on a provisional ID in order to obtain an assigned dynamic address. Each slave device uses its assigned dynamic address for subsequent transactions on the I3C Bus. The assigned dynamic addresses define a priority structure for the slave devices coupled to the serial bus. The priority level of each slave device is encoded in its dynamic address, such that the highest priority device among slave devices has the lowest dynamic address and the lowest priority device among slave devices has the highest dynamic address. Priority level defines the order in which in-band interrupts and other requests are processed by a bus master.

Dynamic addresses are 7 bits in length, and I3C specifications provide that a bus master may assign dynamic addresses within the range {0x03 to 0x7B}. Nominally, a bus master device conducts arbitration procedures in open-drain mode to permit transmission of all potential address bits. The bus master initiates an arbitrable address header 820 to provide opportunities for requests for dynamic address allocation, hot-join and transfer of designation of bus master, for example. The use of open-drain mode rather than push-pull mode results in prolonged arbitrable header transmissions.

I3C specifications provide an address arbitration optimization that can reduce the average arbitrable header transmission time and/or reduce the aggregate time used for transmitting arbitrable headers. According to the I3C specifications, a bus master may limit the dynamic addresses assigned to slave devices to the range {0x03 to 0x3F}, thereby ensuring that the A6 address bit of all slaves is set to logic 0. When any slave device drives its dynamic address on the SDA line 802 of the serial bus during transmission of an arbitrable address header 820, the A6 address bit is the first-transmitted bit, and the master device can immediately determine whether any slave device is transmitting its dynamic address. The bus master can reliably determine that a slave device is transmitting its address when it detects that the SDA line 802 is in a low signaling state during the A6 bit interval 826, and when the dynamic addresses assigned to slave devices are limited to the range {0x03 to 0x3F}. The bus master can transition its line drivers to push-pull mode when the bus master detects that the SDA line 802 is in a high signaling state during the A6 bit interval 826 when the dynamic addresses assigned to slave devices are limited to the range {0x03 to 0x3F}. The use of the limited address range can limit the time spent in open-drain mode, since only the A6 bit is transmitted in open-drain mode.

In certain implementations the address arbitration optimization technique defined by I3C specifications may be rendered inoperative by client application requirements, exigencies, and/or preferences that result in assignment of one or more dynamic addresses with the A6 address bit set to logic 1. For example, an application may redefine relative priorities of some slave devices and may implement the new priority scheme by reassigning dynamic addresses for one or more slave devices. A bus master device may receive an instruction or request from an application that causes the bus master device to assign a dynamic address that has a value greater than 0x3F to a slave device, thereby causing at least one slave device to have a dynamic address that has the A6 address bit set to logic 1. The bus master device may employ a CCC to force assignment of a dynamic address to a slave device. According to I3C specifications, bus master devices maintain a listing of all assigned dynamic addresses and the bus master devices coupled to a serial bus are consequently aware when a dynamic address assignment precludes the use of the I3C-defined address arbitration optimization technique.

Adaptive Address Arbitration Optimization

Certain aspects disclosed herein provide an adaptive address optimization technique that may be used to extend the address arbitration optimization technique defined by I3C specifications. The adaptive address optimization technique can operate in circumstances where at least one slave device is allocated a dynamic address that has the A6 address bit set to logic 1, and the conventional I3C address arbitration optimization procedure becomes unusable. In some implementations, an adaptive address optimization circuit can identify when an address bit is set to logic zero in the dynamic addresses of all slave devices. The adaptive address optimization circuit may be used to determine that push-pull mode can be enabled when the SDA line of a serial bus remains at the logic 1 level during a corresponding bit interval bit of an arbitrable address header.

FIG. 9 illustrates one example of a circuit 900 that can implement an adaptive address optimization technique according to certain aspects disclosed herein. The circuit may be implemented in a bus master device using combinational logic, sequencing logic, a state machine and/or a processor. The bus master device necessarily has knowledge of all dynamic addresses assigned for use of devices coupled to the serial bus. The bus master device may maintain an address list 902 in a set of registers or other storage. In FIG. 9, the address list 902 includes the addresses assigned to N devices, including devices Slave-0 912, Slave-1 914 an Slave-N 916. The bus master device may be configured to determine the common address bits, if any, that are set to zero in every address in the address list 902. In some implementations, a bitwise OR operation is performed on the addresses in the address list 902 to obtain a resultant address 906 that can indicate when the bus master device can transition from open-drain mode to push-pull mode while an arbitrable address header is being transmitted.

In the illustrated example, seven N-input OR gates 904 can determine which address bits, if any, are set to zero. For example, one OR gate 908 receives N signals 910 representative of the state of the A4 bit in each of the N addresses. A logic low at the output 918 of the OR gate 908 indicates that all A4 bits are configured as logic zero. The outputs of the seven N-input OR gates 904 provide a resultant address 906 that may be used by the bus master to determine when open-drain mode can be terminated during transmission of an arbitrable address header. Open-drain mode can be terminated, and push-pull mode enabled when the bus master device detects that an address bit in the arbitrable address header remains high when all slave devices have addresses with the corresponding bit set to zero.

The adaptive address optimization technique implemented using the circuit 900 seamlessly supports the conventional address arbitration optimization technique defined by I3C specifications. The adaptive address optimization technique can be used to terminate open-drain mode at the earliest opportunity by confirming that no device is driving an address in the arbitrable address header. In an example where the most significant bit (A6) in all dynamic addresses is set to logic zero, the circuit 900 indicates that open-drain mode may be terminated at the end of the A6 transmission interval.

In some implementations, the bus master device may use a sequencer, state machine or processor to sequentially OR each of the addresses in the address list 902 to obtain the resultant address 906. In these implementations, the addresses in the address list 902 may be OR'ed after every address allocation procedure and/or after each CCC transmitted to modify an address.

In some instances, the bus master device may transmit the arbitrable address header in push-pull mode if the bus master device predetermines that it can win an arbitration procedure based on the value of the resultant address 906. The bus master device can refrain from using open-drain mode if its dynamic address can win arbitration over the resultant address 906 up to the first-occurring 0-value address bit in the resultant address 906. The bus master device may maintain the resultant address 906 in a register value.

FIG. 10 illustrates an example of address arbitration header timing 1000 when a bus master device employs an adaptive address optimization technique in accordance with certain aspects disclosed herein. The illustrated example may relate to a bus master device that maintains a table 1020 identifying the dynamic addresses assigned to six slave devices. One slave device 1022 has an address in which the A6 bit is set to logic 1, thereby rendering the conventional address arbitration optimization technique defined by I3C specifications ineffective. In accordance with the adaptive address optimization technique disclosed herein, the bus master device may generate a resultant address 1024 where, in this example, the A4 bit 1026 is at logic zero indicating that the A4 address bits 1028 in all assigned dynamic addresses are set to zero. The bus master device may terminate open-drain mode if no device drives the SDA line low during the transmission of the A4 bit interval in the arbitrable address header based on the generated resultant address 1024.

When the bus master device intends to transmit an arbitrable address header, it may configure its bus interface for open-drain mode. The bus master device provides a start condition 1006 by driving the SDA line 1002 low while the SCL line 1004 is held high. The bus master device then begins transmitting a clock signal on the SCL line 1004 to provide timing for the arbitrable address header. The clock signal is at least initially transmitted in accordance with timing specifications for open-drain mode to provide an open-drain bit period 1010. In the illustrated example, the generated resultant address 1024 indicates that address bits A6 and A5 may remain high when one or more slave devices are driving their dynamic addresses on the SDA line 1002. The generated resultant address 1024 also indicates that each known slave device would drive the SDA line 1002 low in the transmission interval 1008 provided for the A4 address bit when the slave device was driving its dynamic addresses on the SDA line 1002. In the illustrated example, the SDA line 1002 remains high in the transmission interval 1008 during which the A4 address bit would be transmitted, indicating that no slave device is driving an address on the SDA line 1002. At the end 1012 of the transmission interval 1008 for the A4 address bit, the bus master device may cause its line drivers to operate in push-pull mode. The bus master device then begins transmitting the clock signal on the SCL line 1004 in accordance with timing specifications for push-pull mode to obtain a shorter push-pull bit period 1014. In FIG. 10, the bit periods 1010, 1014 are not depicted on a common scale.

FIG. 10 includes an example of a logic circuit 1040 that can perform or support decision-making in an adaptive address optimization technique operated in accordance with certain aspects disclosed herein. The illustrated logic circuit 1040 may monitor signaling state of the SDA line 1002 in the transmission interval 1008 provided for the A4 address bit during transmission of an arbitrable address header. An AND gate 1046 receives a first input 1042 corresponding to address bit A4 1026 in the resultant address 1024. In some implementations, the first input 1042 may be received directly from the OR gate 908 (see FIG. 9) that receives N signals 910 representative of the state of the A4 address bit in each of N addresses. The first input 1042 is inverted such that a high logic state indicates that the A4 address bit in the arbitrable address header can be used to determine if early termination of open-drain mode is possible. Here, the first input 1042 enables the AND gate 1046 to pass the logic state of its second input 1044 to its output 1048. The second input 1044 of the AND gate 1046 is a signal representative of the signaling state of the SDA line 1002 during the transmission interval 1008 provided for the A4 address bit. If the signaling state of the SDA line 1002 during the transmission interval 1008 is high, then no slave device is driving its address in the arbitrable address header. The output 1048 of the AND gate 1046 may be used as a flag, interrupt or other signal that causes the bus master device to cause its line drivers to operate in push-pull mode.

Examples of Processing Circuits and Methods

FIG. 11 is a diagram illustrating an example of a hardware implementation for an apparatus 1100 employing a processing circuit 1102 that may be configured to perform one or more functions disclosed herein. In accordance with various aspects of the disclosure, an element, or any portion of an element, or any combination of elements as disclosed herein may be implemented using the processing circuit 1102. The processing circuit 1102 may include one or more processors 1104 that are controlled by some combination of hardware and software modules. Examples of processors 1104 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1104 may include specialized processors that perform specific functions, and that may be configured, augmented or controlled by one of the software modules 1116. The one or more processors 1104 may be configured through a combination of software modules 1116 loaded during initialization, and further configured by loading or unloading one or more software modules 1116 during operation. In various examples, the processing circuit 1102 may be implemented using a state machine, sequencer, signal processor and/or general-purpose processor, or a combination of such devices and circuits.

In the illustrated example, the processing circuit 1102 may be implemented with a bus architecture, represented generally by the bus 1110. The bus 1110 may include any number of interconnecting buses and bridges depending on the specific application of the processing circuit 1102 and the overall design constraints. The bus 1110 links together various circuits including the one or more processors 1104, and storage 1106. Storage 1106 may include memory devices and mass storage devices, and may be referred to herein as computer-readable media and/or processor-readable media. The bus 1110 may also link various other circuits such as timing sources, timers, peripherals, voltage regulators, and power management circuits. A bus interface 1108 may provide an interface between the bus 1110 and one or more transceivers 1112. A transceiver 1112 may be provided for each networking technology supported by the processing circuit. In some instances, multiple networking technologies may share some or all of the circuitry or processing modules found in a transceiver 1112. Each transceiver 1112 provides a means for communicating with various other apparatus over a transmission medium. Depending upon the nature of the apparatus 1100, a user interface 1118 (e.g., keypad, display, speaker, microphone, joystick) may also be provided, and may be communicatively coupled to the bus 1110 directly or through the bus interface 1108.

A processor 1104 may be responsible for managing the bus 1110 and for general processing that may include the execution of software stored in a computer-readable medium that may include the storage 1106. In this respect, the processing circuit 1102, including the processor 1104, may be used to implement any of the methods, functions and techniques disclosed herein. The storage 1106 may be used for storing data that is manipulated by the processor 1104 when executing software, and the software may be configured to implement any one of the methods disclosed herein.

One or more processors 1104 in the processing circuit 1102 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1106 or in an external computer-readable medium. The external computer-readable medium and/or storage 1106 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1106 may also include, by way of example, a carrier wave, a transmission line, and any other suitable medium for transmitting software and/or instructions that may be accessed and read by a computer. Computer-readable medium and/or the storage 1106 may reside in the processing circuit 1102, in the processor 1104, external to the processing circuit 1102, or be distributed across multiple entities including the processing circuit 1102. The computer-readable medium and/or storage 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1106 may maintain software maintained and/or organized in loadable code segments, modules, applications, programs, etc., which may be referred to herein as software modules 1116. Each of the software modules 1116 may include instructions and data that, when installed or loaded on the processing circuit 1102 and executed by the one or more processors 1104, contribute to a run-time image 1114 that controls the operation of the one or more processors 1104. When executed, certain instructions may cause the processing circuit 1102 to perform functions in accordance with certain methods, algorithms and processes described herein.

Some of the software modules 1116 may be loaded during initialization of the processing circuit 1102, and these software modules 1116 may configure the processing circuit 1102 to enable performance of the various functions disclosed herein. For example, some software modules 1116 may configure internal devices and/or logic circuits 1122 of the processor 1104, and may manage access to external devices such as the transceiver 1112, the bus interface 1108, the user interface 1118, timers, mathematical coprocessors, and so on. The software modules 1116 may include a control program and/or an operating system that interacts with interrupt handlers and device drivers, and that controls access to various resources provided by the processing circuit 1102. The resources may include memory, processing time, access to the transceiver 1112, the user interface 1118, and so on.

One or more processors 1104 of the processing circuit 1102 may be multifunctional, whereby some of the software modules 1116 are loaded and configured to perform different functions or different instances of the same function. The one or more processors 1104 may additionally be adapted to manage background tasks initiated in response to inputs from the user interface 1118, the transceiver 1112, and device drivers, for example. To support the performance of multiple functions, the one or more processors 1104 may be configured to provide a multitasking environment, whereby each of a plurality of functions is implemented as a set of tasks serviced by the one or more processors 1104 as needed or desired. In one example, the multitasking environment may be implemented using a timesharing program 1120 that passes control of a processor 1104 between different tasks, whereby each task returns control of the one or more processors 1104 to the timesharing program 1120 upon completion of any outstanding operations and/or in response to an input such as an interrupt. When a task has control of the one or more processors 1104, the processing circuit is effectively specialized for the purposes addressed by the function associated with the controlling task. The timesharing program 1120 may include an operating system, a main loop that transfers control on a round-robin basis, a function that allocates control of the one or more processors 1104 in accordance with a prioritization of the functions, and/or an interrupt driven main loop that responds to external events by providing control of the one or more processors 1104 to a handling function.

FIG. 12 is a flowchart 1200 illustrating a method for a bus arbitration procedure that may be performed at a master device coupled to a serial bus. The serial bus may be operated in accordance with one or more I3C protocols. The bus arbitration procedure may implement adaptive address arbitration optimization in accordance with certain aspects of this disclosure. In one example, the procedure relates to an arbitration process used to permit a slave device to gain access to the serial bus.

At block 1202, the master device may determine that at least one device coupled to a serial bus has been assigned a dynamic address with a non-zero most significant address bit. For example, the dynamic address assigned to one slave device 1022 in FIG. 12 has a non-zero A6 address bit. At block 1204, the master device may determine that all devices coupled to the serial bus have been assigned dynamic addresses that have a common zero-value address bit. For example, the A4 address bits 1028 of all dynamic addresses in the table 1020 of FIG. 12 have a logic zero value. At block 1206, the master device may initiate transmission of an arbitrable address header while a line driver coupled to a data line of the serial bus is configured for an open-drain mode of operation. At block 1208, the master device may configure the line driver coupled to the data line for a push-pull mode of operation when a bit in the arbitrable address header corresponding to the common zero-value address bit has a non-zero value on the data line. In some implementations the serial bus is operated in accordance with an Improved Inter-Integrated Circuit (I3C) protocol.

In one example, the master device may transmit a clock signal on a clock line of the serial bus. The clock signal may be transmitted with a higher frequency when the line driver coupled to the data line is configured for a push-pull mode of operation than when the line driver coupled to the data line is configured for an open-drain mode of operation.

In certain examples, the master device may determine that all devices coupled to the serial bus have been assigned dynamic addresses that have the common zero-value address bit by performing a bitwise OR operation on the dynamic addresses of all devices coupled to the serial bus to obtain a resultant address. Each bit of the resultant address that has a zero value may indicate a bit interval in the arbitrable address header that can be used to transition the line driver coupled to the data line from open-drain mode to push-pull mode. The common zero-value address bit may correspond to a bit in the resultant address that has greater significance than other zero-value bits in the resultant address. The bitwise OR operation may be performed after a dynamic address has been assigned to a slave device.

FIG. 13 is a diagram illustrating an example of a hardware implementation for an apparatus 1300 employing a processing circuit 1302. In one example, the apparatus 1300 is configured for data communication over a serial bus that is operated in accordance with one or more I3C protocols. The processing circuit typically has a controller or processor 1316 that may include one or more microprocessors, microcontrollers, digital signal processors, sequencers and/or state machines. The processing circuit 1302 may be implemented with a bus architecture, represented generally by the bus 1320. The bus 1320 may include any number of interconnecting buses and bridges depending on the specific application of the processing circuit 1302 and the overall design constraints. The bus 1320 links together various circuits including one or more processors and/or hardware modules, represented by the controller or processor 1316, the modules or circuits 1304, 1306 and 1308, and the processor-readable storage medium 1318. The apparatus may be coupled to a multi-wire communication link using a physical layer circuit such as the bus interface circuit 1314. The bus interface circuit 1314 may operate the multi-wire serial bus 1312 to support communications in accordance with I3C protocols. The bus 1320 may also link various other circuits such as timing sources, peripherals, voltage regulators, and power management circuits, which are well known in the art, and therefore, will not be described any further.

The processor 1316 is responsible for general processing, including the execution of software, code and/or instructions stored on the processor-readable storage medium 1318. The processor-readable storage medium 1318 may include non-transitory storage media. The software, when executed by the processor 1316, causes the processing circuit 1302 to perform the various functions described supra for any particular apparatus. The processor-readable storage medium 1318 may be used for storing data that is manipulated by the processor 1316 when executing software. The processing circuit 1302 further includes at least one of the modules 1304, 1306 and 1308. The modules 1304, 1306 and 1308 may be software modules running in the processor 1316, resident/stored in the processor-readable storage medium 1318, one or more hardware modules coupled to the processor 1316, or some combination thereof. The modules 1304, 1306 and 1308 may include microcontroller instructions, state machine configuration parameters, or some combination thereof.

In one configuration, the apparatus 1300 includes a bus interface circuit 1314 that may include one or more line driver circuits that couple the apparatus 1300 to a multi-wire serial bus 1312. The apparatus 1300 includes modules and/or circuits 1308 configured to maintain a listing of addresses of devices coupled to the multi-wire serial bus 1312, modules and/or circuits 1306 configured to initiate and conduct address arbitration processes on the serial bus and/or to manage dynamic address allocation procedures, and modules and/or circuits 1304 configured to control operation of line driver circuits in the bus interface circuit 1314, including configuring the line driver circuits for open-drain, push-pull and/or other modes of operation.

In one example, the apparatus 1300 includes a processor 1316 configured to determine that at least one device coupled to a serial bus has been assigned a dynamic address with a non-zero most significant address bit, determine that all devices coupled to the multi-wire serial bus 1312 have been assigned dynamic addresses that have a common zero-value address bit, cause the bus interface to initiate transmission of an arbitrable address header while the line driver is configured for an open-drain mode of operation, and configure the line driver for a push-pull mode of operation when a bit in the arbitrable address header corresponding to the common zero-value address bit has a non-zero value on the data line. In an example related to the address allocation illustrated in FIG. 10, the processor 1316 may determine that the A4 address bits 1028 of all devices have a common logic zero value. The multi-wire serial bus 1312 may be operated in accordance with an I3C protocol.

In some implementations, the bus interface circuit 1314 is configured to transmit a clock signal on a clock line of the multi-wire serial bus 1312. The clock signal may be transmitted with a higher frequency when the line driver coupled to the data line is configured for a push-pull mode of operation than when the line driver coupled to the data line is configured for an open-drain mode of operation.

In some implementations, the apparatus 1300 includes a logic circuit configured to perform a bitwise OR operation on the dynamic addresses of all devices coupled to the serial bus to obtain a resultant address. The processor 1316 may be further configured to use the resultant address to determine that all devices coupled to the multi-wire serial bus 1312 have been assigned dynamic addresses that have the common zero-value address bit. Each bit of the resultant address that has a zero value may indicate a bit interval in the arbitrable address header that can be used to transition the line driver coupled to the data line from open-drain mode to push-pull mode. The common zero-value address bit may correspond to a bit in the resultant address that has greater significance than other zero-value bits in the resultant address. The bitwise OR operation may be performed after a dynamic address has been assigned to a slave device.

The processor-readable storage medium 1318 may include instructions that cause the processing circuit 1302 to determine that at least one device coupled to the multi-wire serial bus 1312 has been assigned a dynamic address with a non-zero most significant address bit, determine that all devices coupled to the multi-wire serial bus 1312 have been assigned dynamic addresses that have a common zero-value address bit, initiate transmission of an arbitrable address header while a line driver coupled to a data line of the multi-wire serial bus 1312 is configured for an open-drain mode of operation, and configure the line driver coupled to the data line for a push-pull mode of operation when a bit in the arbitrable address header corresponding to the common zero-value address bit has a non-zero value on the data line. The multi-wire serial bus 1312 may be operated in accordance with an I3C protocol. The processor-readable storage medium 1318 may include a non-transitory storage medium.

In some instances, the processor-readable storage medium 1318 includes code which causes the processor 1316 to transmit a clock signal on a clock line of the multi-wire serial bus 1312. The clock signal may be transmitted with a higher frequency when the line driver coupled to the data line is configured for a push-pull mode of operation than when the line driver coupled to the data line is configured for an open-drain mode of operation.

In some instances, the processor-readable storage medium 1318 includes code which causes the processing circuit 1302 to perform a bitwise OR operation on the dynamic addresses of all devices coupled to the multi-wire serial bus 1312 to obtain a resultant address, and use the resultant address to determine that all devices coupled to the multi-wire serial bus 1312 have been assigned dynamic addresses that have the common zero-value address bit. Each bit of the resultant address that has a zero value may indicate a bit interval in the arbitrable address header that can be used to transition the line driver coupled to the data line from open-drain mode to push-pull mode. The common zero-value address bit may correspond to a bit in the resultant address that has greater significance than other zero-value bits in the resultant address. The bitwise OR operation may be performed after a dynamic address has been assigned to a slave device.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for bus arbitration, comprising:
determining that at least one device coupled to a serial bus has been assigned a dynamic address with a non-zero most significant address bit;
determining that all devices coupled to the serial bus have been assigned dynamic addresses that have a common zero-value address bit;
initiating transmission of an arbitrable address header while a line driver coupled to a data line of the serial bus is configured for an open-drain mode of operation; and
configuring the line driver coupled to the data line for a push-pull mode of operation when a bit in the arbitrable address header corresponding to the common zero-value address bit has a non-zero value on the data line.

2. The method of claim 1, wherein the serial bus is operated in accordance with an Improved Inter-Integrated Circuit (I3C) protocol.

3. The method of claim 1, further comprising:
transmitting a clock signal on a clock line of the serial bus, wherein the clock signal is transmitted with a higher frequency when the line driver coupled to the data line is configured for the push-pull mode of operation than when the line driver coupled to the data line is configured for the open-drain mode of operation.

4. The method of claim 1, wherein determining that all the devices coupled to the serial bus have been assigned the dynamic addresses that have the common zero-value address bit comprises:
performing a bitwise OR operation on the dynamic addresses of all the devices coupled to the serial bus to obtain a resultant address.

5. The method of claim 4, wherein each bit of the resultant address that has a zero value indicates a bit interval in the arbitrable address header that can be used to transition the line driver coupled to the data line from open-drain mode to push-pull mode.

6. The method of claim 4, wherein the common zero-value address bit corresponds to a bit in the resultant address that has greater significance than other zero-value bits in the resultant address.

7. The method of claim 4, wherein the bitwise OR operation is performed after a dynamic address has been assigned to a slave device.

8. An apparatus configured for data communication, comprising:
a bus interface having a line driver configured to couple the apparatus to a data line of a serial bus; and
a processor configured to:
determine that at least one device coupled to the serial bus has been assigned a dynamic address with a non-zero most significant address bit;
determine that all devices coupled to the serial bus have been assigned dynamic addresses that have a common zero-value address bit;
cause the bus interface to initiate transmission of an arbitrable address header while the line driver is configured for an open-drain mode of operation; and
configure the line driver for a push-pull mode of operation when a bit in the arbitrable address header corresponding to the common zero-value address bit has a non-zero value on the data line.

9. The apparatus of claim 8, wherein the serial bus is operated in accordance with an Improved Inter-Integrated Circuit (I3C) protocol.

10. The apparatus of claim 8, wherein the bus interface is configured to:
transmit a clock signal on a clock line of the serial bus, wherein the clock signal is transmitted with a higher frequency when the line driver coupled to the data line is configured for the push-pull mode of operation than when the line driver coupled to the data line is configured for the open-drain mode of operation.

11. The apparatus of claim 8, further comprising:
a logic circuit configured to perform a bitwise OR operation on the dynamic addresses of all the devices coupled to the serial bus to obtain a resultant address,
wherein the processor is further configured to use the resultant address to determine that all the devices coupled to the serial bus have been assigned the dynamic addresses that have the common zero-value address bit.

12. The apparatus of claim 11, wherein each bit of the resultant address that has a zero value indicates a bit interval in the arbitrable address header that can be used to transition the line driver coupled to the data line from open-drain mode to push-pull mode.

13. The apparatus of claim 11, wherein the common zero-value address bit corresponds to a bit in the resultant address that has greater significance than other zero-value bits in the resultant address.

14. The apparatus of claim 11, wherein the bitwise OR operation is performed after a dynamic address has been assigned to a slave device.

15. A non-transitory processor-readable storage medium including code which, when executed by a processor, causes the processor to:
determine that at least one device coupled to a serial bus has been assigned a dynamic address with a non-zero most significant address bit;
determine that all devices coupled to the serial bus have been assigned dynamic addresses that have a common zero-value address bit;
initiate transmission of an arbitrable address header while a line driver coupled to a data line of the serial bus is configured for an open-drain mode of operation; and
configure the line driver coupled to the data line for a push-pull mode of operation when a bit in the arbitrable address header corresponding to the common zero-value address bit has a non-zero value on the data line.

16. The storage medium of claim 15, wherein the serial bus is operated in accordance with an Improved Inter-Integrated Circuit (I3C) protocol.

17. The storage medium of claim 15, further comprising code which causes the processor to:
transmit a clock signal on a clock line of the serial bus, wherein the clock signal is transmitted with a higher frequency when the line driver coupled to the data line is configured for the push-pull mode of operation than when the line driver coupled to the data line is configured for the open-drain mode of operation.

18. The storage medium of claim 15, further comprising code which causes the processor to:
perform a bitwise OR operation on the dynamic addresses of all the devices coupled to the serial bus to obtain a resultant address; and
use the resultant address to determine that all the devices coupled to the serial bus have been assigned the dynamic addresses that have the common zero-value address bit.

19. The storage medium of claim 18, wherein each bit of the resultant address that has a zero value indicates a bit interval in the arbitrable address header that can be used to transition the line driver coupled to the data line from open-drain mode to push-pull mode.

20. The storage medium of claim 18, wherein the common zero-value address bit corresponds to a bit in the resultant address that has greater significance than other zero-value bits in the resultant address.

21. The storage medium of claim 18, wherein the bitwise OR operation is performed after a dynamic address has been assigned to a slave device.

22. An apparatus configured for data communication, comprising:
means for determining content of device addresses, configured to determine that at least one device coupled to a serial bus has been assigned a dynamic address with a non-zero most significant address bit and further configured to determine that all devices coupled to the serial bus have been assigned dynamic addresses that have a common zero-value address bit;
means for initiating transmission of an arbitrable address header while a line driver coupled to a data line of the serial bus is configured for an open-drain mode of operation; and
means for configuring the line driver coupled to the data line for a push-pull mode of operation when a bit in the arbitrable address header corresponding to the common zero-value address bit has a non-zero value on the data line.

23. The apparatus of claim 22, wherein the serial bus is operated in accordance with an Improved Inter-Integrated Circuit (I3C) protocol.

24. The apparatus of claim 22, further comprising:
means for transmitting a clock signal on a clock line of the serial bus, wherein the clock signal is transmitted with a higher frequency when the line driver coupled to the data line is configured for the push-pull mode of operation than when the line driver coupled to the data line is configured for the open-drain mode of operation.

25. The apparatus of claim 22, wherein the means for determining the content of device addresses includes a logic circuit configured to:
perform a bitwise OR operation on the dynamic addresses of all the devices coupled to the serial bus to obtain a resultant address, wherein the resultant address is used to determine that all the devices coupled to the serial bus have been assigned the dynamic addresses that have the common zero-value address bit.

26. The apparatus of claim 25, wherein each bit of the resultant address that has a zero value indicates a bit interval in the arbitrable address header that can be used to transition the line driver coupled to the data line from open-drain mode to push-pull mode.

27. The apparatus of claim 25, wherein the common zero-value address bit corresponds to a bit in the resultant address that has greater significance than other zero-value bits in the resultant address.

28. The apparatus of claim 25, wherein the bitwise OR operation is performed after a dynamic address has been assigned to a slave device.
